(19) United States
(12) Patent Application Publication
(10) Pub. No.: US 2004/0060143 A1
(43) Pub. Date: Apr. 1, 2004

(54) Pressurizing structure for windshield wiper

(75) Inventor: Shun Tian Shuen, San Chung City (TW)

Correspondence Address: BACON & THOMAS, PLLC, 625 SLATERS LANE, FOURTH FLOOR, ALEXANDRIA, VA, 22314

(73) Assignee: JANCHY ENTERPRISE CO., LTD., Taipei (TW)

(21) Appl. No.: 10/256,084

(22) Filed: Sep. 27, 2002

(51) Int. Cl. B60S 1/32

(52) U.S. Cl. 15/250.201; 15/250.351; 15/257.01

(57) ABSTRACT

Pressurizing structure for windshield wiper, including an enclosing case, an extensible case, decorative boards and pressurizing plate. The enclosing case and the extensible case are telescopically connected for accommodating therein various specifications of wiper arms. The decorative boards are disposed on the surfaces of the enclosing case and the extensible case. A bottom board is disposed under bottom faces of the enclosing case and the extensible case to seal the same. Multiple restricting blocks with different patterns of receiving recesses are inlaid in the enclosing case to truly locate respective portions of the wiper arm. The pressurizing plate is connected with a tip of the enclosing case to keep the scraper of the wiper arm parallel to the windshield so as to truly clean up the same. A locating block is disposed under bottom face of the pressurizing plate, whereby in accordance with the position of the scraper of the wiper arm, the pressurizing plate can be adjusted and truly located.

### BACKGROUND OF THE INVENTION

The present invention is related to an improved pressurizing structure for windshield wiper, which is able to keep the scraper of the wiper arm tightly attaching to the windshield so as to truly clean up the same. The pressurizing structure also provides decorative effect and is applicable to various specifications of windshield wipers.

A conventional windshield wiper has a scraper. The wiper is reciprocally moved, whereby the scraper can wipe off the water and dirt remaining on the windshield for a driver to have clear sight. The conventional wiper arm via a simple resilient clip structure is connected with a driving shaft. The wiper arm can be pivoted to a position normal to the windshield for a user to clean the windshield or replace the wiper arm with a new one. After a long period of use, the resilient clip is subject to elastic failure. Under such circumstance, the scraper will be unable to be parallel to the windshield and tightly attach thereto. As a result, the scraper will be unable to fully scrape off the water and dirt. Furthermore, the conventional windshield wiper lacks decorative function. Also, the wiper arm is metal-made and subject to rusting. This will ruin the appearance of the wiper.

### SUMMARY OF THE INVENTION

It is therefore a primary object of the present invention to provide an improved pressurizing structure for windshield wiper, which is able to keep the scraper of the wiper arm tightly attaching to the windshield so as to truly clean up the water and dirt remaining on the windshield.

It is a further object of the present invention to provide the above pressurizing structure which is applicable to various specifications of wiper arms.

It is still a further object of the present invention to provide the above pressurizing structure which also provides decorative effect to highlight personal style.

The present invention can be best understood through the following description and accompanying drawings wherein:

### BRIEF DESCRIPTION OF THE DRAWINGS

FIG. 1 is a perspective exploded view of the present invention;

FIG. 2 is a perspective view of the locating block of the present invention;

FIG. 3 is a perspective assembled view of the present invention;

FIG. 4 shows that the extensible case of the present invention is telescopically adjustable;

FIG. 5 shows that the present invention is to be connected with the wiper arm;

FIG. 6 shows that the present invention is connected with the wiper arm; and

FIG. 7 is a perspective view of another embodiment of the present invention.

### DETAILED DESCRIPTION OF THE PREFERRED EMBODIMENTS

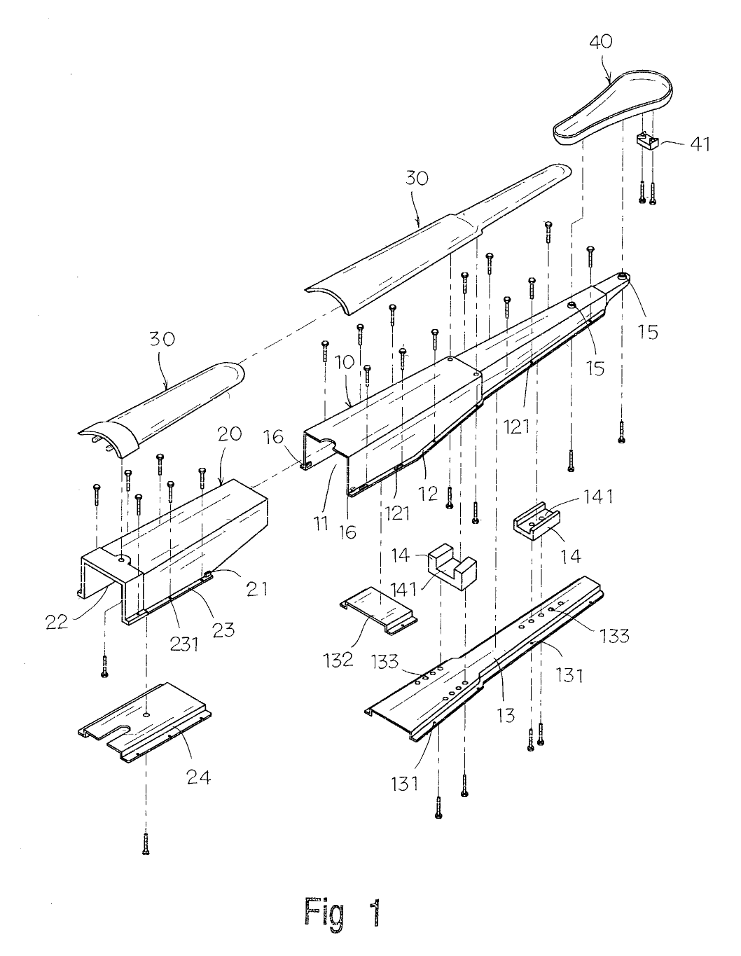

Please refer to FIG. 1. The pressurizing structure for windshield wiper of the present invention includes an enclosing case 10 which is formed with two steps and has an elongated conic profile. The enclosing case 10 defines a cavity 11 for accommodating therein the wiper arm 50. The edges of two lateral walls of the cavity 11 are formed with horizontal connecting edges 12 having multiple locating holes 121. The edges of a bottom board 13 and a connecting board 132 are also formed with multiple locating holes 131. By means of screws, the bottom board 13 and connecting board 132 are locked with the enclosing case 10 to seal the cavity 11. In addition, restricting blocks 14 having different patterns of receiving recesses 141 are inlaid in the cavity 11. The face of the bottom board 13 is formed with multiple adjustment holes 133 corresponding to the restricting blocks 14. By means of screws, the restricting blocks 14 are fixed to truly locate respective portions of the wiper arm 50. A decorative board 30 is adhered to the surface of the enclosing case 10. The enclosing case 10 is formed with through holes 15 near front end thereof. By means of screws passing through the through holes 15, a pressurizing plate 40 is connected with the enclosing case 10. The inner wall face of rear end of the enclosing case 10 is formed with projecting stopper edge 16 for connecting with an extensible case 20 and preventing the extensible case 20 from detaching from the enclosing case 10.

The bottom board 13 and connecting board 132 both have substantially U-shaped cross-section. In accordance with the thickness of the wiper arm 50, the bottom board 13 and connecting board 132 can be selectively connected with the enclosing case 10 on front face or back face.

The extensible case 20 has a U-shaped cross-section and a substantially conic profile. One end of the extensible case 20 is inserted into the rear end of the enclosing case 10 and connected therewith. The bottom face of the extensible case 20 is formed with projecting restricting edges 21 corresponding to the stopper edges 16. The extensible case 20 defines a cavity 22 for accommodating therein the wiper arm 50. A decorative board 30 is fixed on the outer face of the extensible case 20 for achieving a decorative and beautifying effect. The edges of two lateral walls of the cavity 22 are horizontally bent to form connecting edges 23 having multiple locating holes 231. A bottom board 24 is disposed under bottom face of the cavity 22 for sealing the cavity 22. The bottom board 24 has a substantially U-shaped cross-section. In accordance with the thickness of the wiper arm 50, the bottom board 24 can be selectively connected with the extensible case 20 on front face or back face.

Two decorative boards 30 are respectively fixedly disposed on top faces of the enclosing case 10 and extensible case 20. In cooperation with the telescopic design of the enclosing case 10 and extensible case 20, the two decorative boards 30 are designed with telescopic patterns.

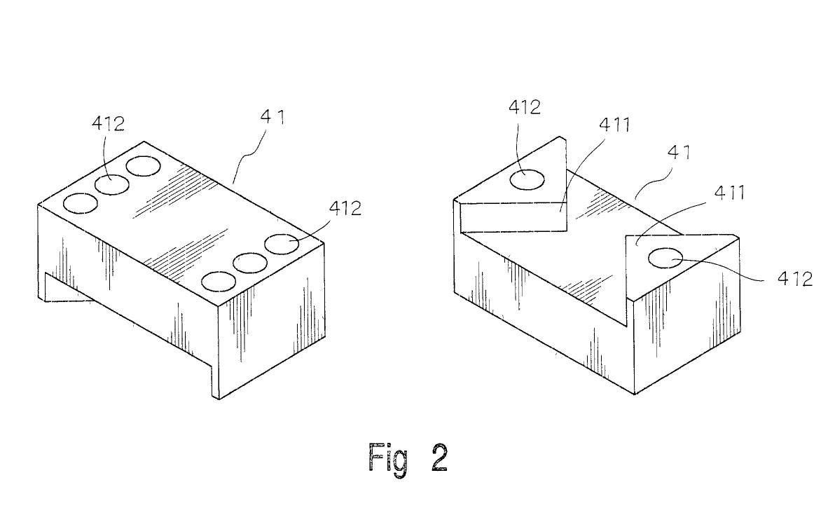

A calabash-shaped pressurizing plate 40 is formed with a central depression. The outer edge of the pressurizing plate 40 is connected with a locating block 41. Referring to FIG. 2, one face of the locating block 41 is formed with two sharp projecting sections 411 opposite to each other. The locating block 41 is also formed with multiple through holes 412 for adjusting locating direction, whereby in accordance with the position of the scraper 51 of the wiper arm 50, the pressurizing plate 40 can be adjusted and truly located.

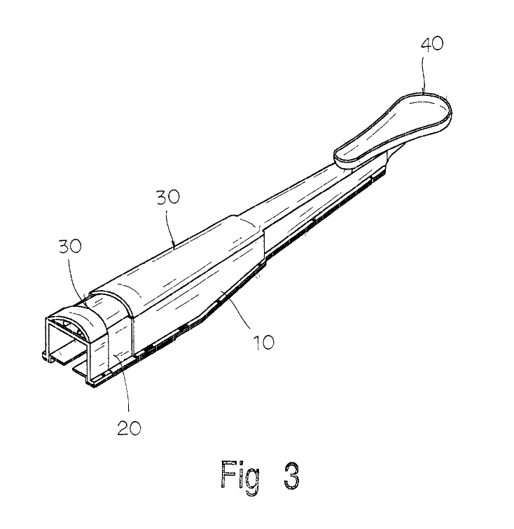

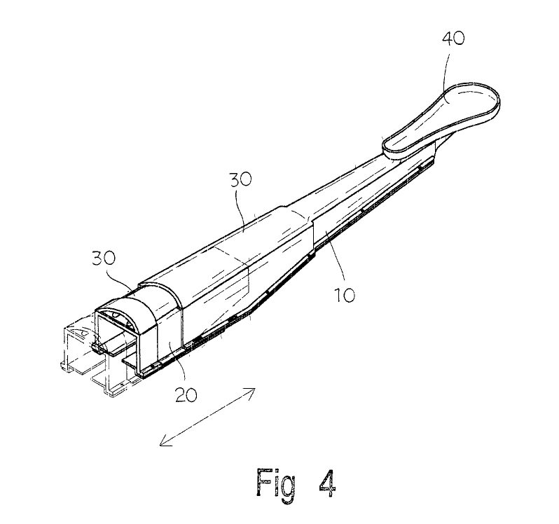

When assembled, one end of the extensible case 20 is inserted into the rear end of the enclosing case 10. The restricting edges 21 are engaged with the stopper edges 16 to prevent the extensible case 20 from detaching from the enclosing case 10 as shown in FIG. 4. Then the pressurizing plate 40 is connected with the tip of the enclosing case 10 to form the pressurizing structure for windshield wiper as shown in FIG. 3.

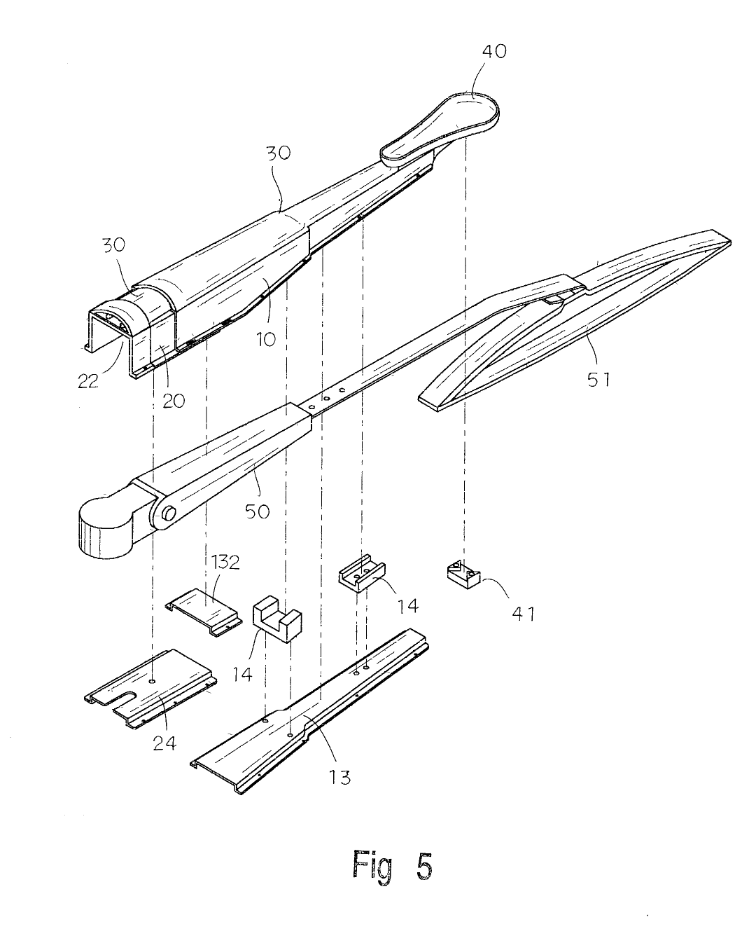

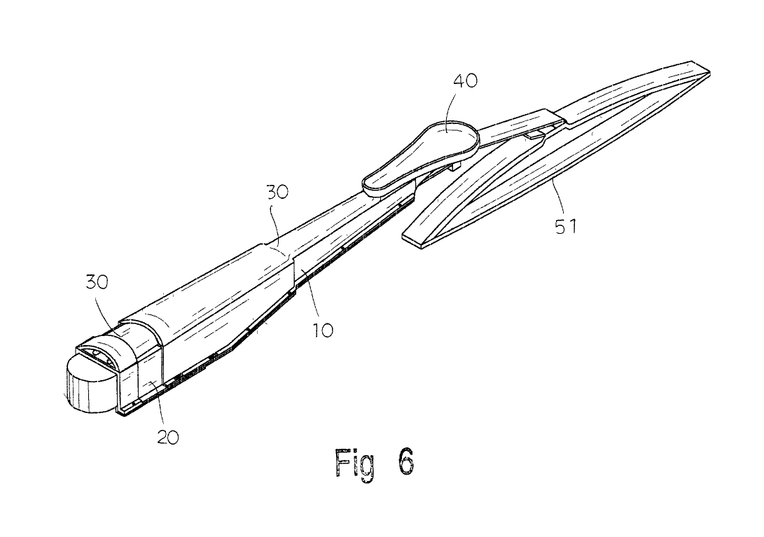

Referring to FIG. 5, in practical use, the enclosing case 10 and extensible case 20 are first connected with the windshield wiper arm 50. The wiper arm 50 is placed into the cavities 11, 22. Then several restricting blocks 14 with the same pattern of receiving recesses 141 are used to locate the respective portions of the wiper arm 50. Finally, depending on whether the thickness of the wiper arm 50 exceeds the cavity 11 or 22, the bottom boards 13, 24 are selectively connected with the enclosing case 10 and extensible case 20 with front face or back face facing upward as shown in FIG. 6.

In use, when a car runs, by means of the pressurizing plate 40 at front end of the enclosing case 10, the area suffering wind pressure is increased. Accordingly, the scraper 51 of the wiper arm 50 is kept parallel to the windshield so as to truly clean up the same. In fact, the wiper arms 50 of different models of cars have different lengths. Therefore, in order to widely apply the present invention to most of the cars, the enclosing case 10 and the extensible case 20 are telescopically connected with each other.

In addition, the decorative boards 30 disposed on the surfaces of the enclosing case 10 and the extensible case 20 can be replaced as personally desired to beautify the appearance of the windshield wiper and highlight personal style.

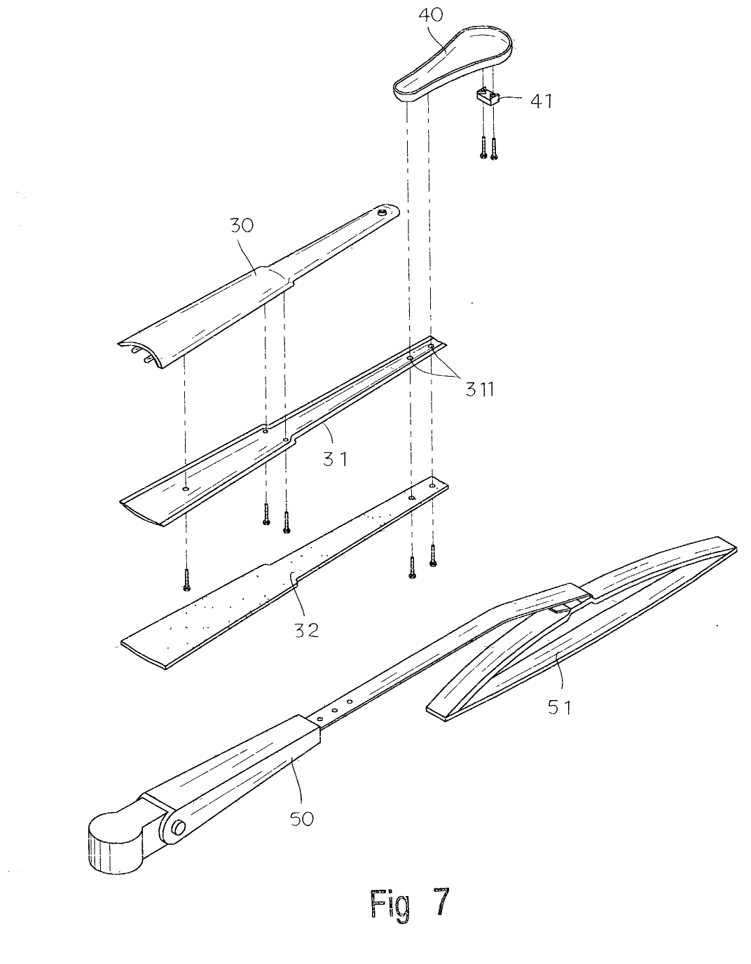

FIG. 7 shows a simplified structure of the present invention, in which only the decorative board 30 and the pressurizing plate 40 remain and a bottom decorative board 31 cooperates with the decorative board 30. The bottom decorative board 31 has a projecting sharp end formed with perforations 311. Screws are passed through the perforations 311 to lock the pressurizing plate 40 with the bottom decorative plate 31. A double-face tape 32 is used to adhere the bottom decorative board 31 to the wiper arm 50. Accordingly, the forced area of the wiper arm 50 is increased to keep the scraper parallel to the windshield for truly cleaning up the same. The decorative plate 30 can be replaced as personally desired to beautify the appearance of the windshield wiper and highlight personal style.

The above embodiments are only used to illustrate the present invention, not intended to limit the scope thereof. Many modifications of the above embodiments can be made without departing from the spirit of the present invention.

What is claimed is:

1. Pressurizing structure for windshield wiper, comprising an enclosing case, an extensible case, decorative boards and pressurizing plate, the enclosing case defining a cavity for accommodating therein the wiper arm, a bottom board and a connecting board sealing the cavity, the pressurizing plate being connected with a tip of the enclosing case, the extensible case being telescopically nested in rear end of the enclosing case, the wiper arm being inserted in the extensible case, a bottom board being disposed under bottom face of the extensible case for sealing the same, the decorative boards being fixedly disposed on top faces of the enclosing case and extensible case, said pressurizing structure being characterized in that multiple restricting blocks with different patterns of receiving recesses are inlaid in the cavity of the enclosing case and the face of the bottom board is formed with multiple adjustment holes corresponding to the restricting blocks, whereby by means of screws passing through the adjustment holes, the restricting blocks are fixed to truly locate respective portions of the wiper arm.

2. Pressurizing structure for windshield wiper as claimed in claim 1, wherein an outer edge of the pressurizing plate is connected with a locating block, one face of the locating block being formed with two sharp projecting sections opposite to each other, the locating block being formed with multiple through holes for adjusting locating direction, whereby in accordance with the position of the scraper of the wiper arm, the pressurizing plate can be adjusted and truly located.

3. Pressurizing structure for windshield wiper as claimed in claim 1, wherein the edges of two lateral walls of each of the enclosing case and extensible case are horizontally bent to form connecting edges having multiple locating holes.

4. Pressurizing structure for windshield wiper as claimed in claim 1 or 3, wherein the bottom board and connecting board have substantially U-shaped cross-section, whereby in accordance with the thickness of the wiper arm, the bottom board and connecting board can be selectively connected with the enclosing case and extensible case on front face or back face.

5. Pressurizing structure for windshield wiper as claimed in claim 1, wherein in cooperation with the telescopic design of the enclosing case and extensible case, the decorative boards are designed with telescopic patterns.

6. Pressurizing structure for windshield wiper as claimed in claim 1 or 3, wherein the pressurizing structure is such simplified that only a decorative board and pressurizing plate remain and a bottom decorative board cooperates with the decorative board, the bottom decorative board having a projecting sharp end on which the pressurizing plate is locked, a double-face tape being used to adhere the bottom decorative board to the wiper arm.
